(19) United States
(12) Patent Application Publication
(10) Pub. No.: US 2008/0084202 A1
(43) Pub. Date: Apr. 10, 2008

(54) VEHICULAR ROTATION SPEED SENSING APPARATUS

(75) Inventor: Chen Chieh Shing, Guishan Shiang (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Acewell International Co., Ltd.

(21) Appl. No.: 11/539,199

(22) Filed: Oct. 6, 2006

(51) Int. Cl. G01P 3/48

(52) U.S. Cl. 324/174; 324/175

(57) ABSTRACT

A vehicular rotation speed sensing apparatus contains a base, a spindle pivoted inside the base, whose one end is mounted to a magnetic force device axially. The vehicular rotation speed sensing apparatus further includes a magnetic force sensor mounted along the axial direction of the spindle and fastened on the base, so as to sense the variation of the magnetic field lines of the magnetic force device. The magnetic force device is located between the spindle and the magnetic force sensor and the spindle rotates in the spindle hole by inserting the spindle in the spindle hole on the wheel base of motorcycle.

### FIELD OF THE INVENTION

The present invention relates to a rotation speed sensing apparatus, more particularly to a rotation speed sensing apparatus applied to vehicles so as to obtain the data concerning hourly speed, mileage and the like thereof by means of the rotation speed measurement.

### BACKGROUND OF THE INVENTION

Most of the conventional rotation speed sensing apparatus of motorcycle as shown in FIG. 1 often has a spindle hole 32 on the output shaft 34 of the front wheel (not shown) so as to socket the spindle 30 therein. As a result, when the front wheel is spun, the spindle 30 is driven to rotate along therewith. The spindle 30 is further connected to one end of the steel cable 4 so that the steel cable 4 is also rotatable with the spindle 30. The steel cable 4 is sheathed in a protection cover 40 for being protected from abrasion. A speedometer 9 is connected to the other end of the steel cable 4 and the rotation of the steel cable 4 is transformed into the swing of the indicator by means of the mechanism of the speedometer 9. As the concept is commonplace to know, it will no longer be described in details here.

Besides, the spindle 30 is pivoted inside a base 1 and further boltedly connected with the output shaft seat 22 by means of a fixing part 20. The output shaft seat 22 is fastened on the axle stand of front wheel of the motorcycle.

Whereas, such conventional structure also has its drawbacks, and one among them is the poor sensitivity. When the front wheel of motorcycle is rotated in a low speed, the swing magnitude of the indicator of the speedometer 9 is significantly small or the indicator of the speedometer 9 is even motionless. Another drawback is the slow response. The indicator is unable to immediately react upon the abrupt speed variation because of the inertia of the mechanical structure itself and the material characteristics associated with the mechanical structure itself, such as the elasticity, the rigidity and the like. In addition, other issues resulting from the mechanical structure, such as the abrasion, the fatigue and so forth also lead to such drawback.

Furthermore, if the steel cable 4 is ruptured due to accident, it is hard to be repaired manually, and shall be replaced with a new one at the garage, making it helpless during contingency.

Moreover, the most important is the conventional mechanical structure for transmitting the rotation of front wheel shown in FIG. 1 is awkward to be assembled with an electronic display panel. For the electronic display panel, since the signal provided by the electronic sensor is transmitted by means of electrical coupling, hence the conventional mechanical structure shown in FIG. 1 is not suitable therefor.

Please refer to FIG. 2, which shows an improved wheel for overcoming the mentioned drawback. As shown in FIG. 2, the improved wheel 200 has a central axis 220 with a sleeve 222 extending therefrom, and a ring slot 224 is configured on one side of the sleeve 222, so that a magnetic ring 226 is inserted therein. The ring slot 224 is enclosed by a cover 100 with a magnetic force sensor 102 installed therein so as to transmit the magnetic signal sensed via a wire 104 to the signal adapter 106 which is further connected with an electronic display panel (not shown).

Besides, an electronic sensor for measuring the rotation speed of wheel is disclosed in the Taiwan Patent No. 495051. Such an electronic sensor is disadvantageous in that the wheel 200 and the central axis 200 therewith have to be further designed for adopting therein. Therefore, the mentioned electronic sensor is unable to be applied in the conventional rotation speed sensing apparatus as shown in FIG. 1 and certain parts thereof such as the spindle hole 32 and the output shaft 34 are not applicable due to the structural infeasibility of the electronic sensor. In fact, this results in an enormous loss and an ineffective cost.

For overcoming the mentioned drawbacks, a new electronic wheel rotation speed sensing apparatus in terms of structural linkage for transmitting the rounds of rotation with the existing mechanical transmission means is urgently demanded.

### SUMMARY OF THE INVENTION

In accordance with a first aspect of the present invention, a vehicular rotation speed sensing apparatus is provided. The provided vehicular rotation speed sensing apparatus contains a base, a spindle pivoted inside the base and rotating in a spindle hole, a magnetic force device mounted on one end of the spindle, and a magnetic force sensor mounted on the base along an axial direction of the spindle so as to sense a variation of magnetic field lines of the magnetic force device located between the spindle and the magnetic force sensor.

Preferably, the spindle has a center with an extension line passing through a middle point between a North and a South Pole of the magnetic force device.

Preferably, the magnetic force device is mounted on an end face of the spindle.

Preferably, the sensing apparatus contains a metal wire, and a signal is outputted by the magnetic force sensor via the metal wire.

Preferably, the sensing apparatus contains an optical fiber, and a signal is outputted by the magnetic force sensor via the optical fiber.

Preferably, the sensing apparatus is fixed on a front wheel base of a motorcycle.

Preferably, the sensing apparatus is fixed on a gearbox.

In accordance with a second aspect of the present invention, a vehicular rotation speed sensing apparatus is provided. The provided vehicular rotation speed sensing apparatus contains a base, a spindle pivoted inside the base, rotating in a spindle hole and having a grating disposed thereon, and an optoelectronic sensor fixed on the base for sensing a grating motion.

Preferably, an aperture orientation of the grating is disposed and has a center point being a center of the spindle, and the optoelectronic sensor contains a light-emitting component, and a receiving component mounted opposite to a luminescing direction of the light-emitting component in formation of a rotation space between the receiving component and the light-emitting component with the aperture orientation of the rotation space in parallel with an axial direction of the spindle so as to accommodate the grating to be rotated within the rotation space.

Preferably, the grating is mounted around a periphery of the spindle, an aperture orientation of the grating is parallel with an axial direction of the spindle, the optoelectronic sensor includes a light-emitting component and a receiving component, mounted opposite to a luminescing direction of the light-emitting component in formation of a rotation space between the receiving component and the light-emitting component so as to accommodate the grating to be rotated within the rotation space.

Preferably, an aperture orientation of the grating is positioned alongside an axial direction of the spindle, and the optoelectronic sensor includes a light-emitting component mounted on the base and a receiving component mounted on the base opposite to the light-emitting component, and the grating is located between the light-emitting component and the receiving component.

Preferably, the optoelectronic sensor employs an IR as a light source.

Preferably, the sensing apparatus is fixed on a front wheel base of a motorcycle.

Preferably, the sensing apparatus is fixed on a gearbox.

In accordance with a third aspect of the present invention, a vehicular rotation speed sensing apparatus is provided. The vehicular rotation speed sensing apparatus contains a base, a spindle pivoted inside the base and rotated together with a spindle hole, and a scanner fastened on the base for scanning a rotation of the spindle.

Preferably, the spindle contains a first end received in the spindle hole and a second end, and the scanner contains a light source, and an image grabbing unit grabbing an image data formed by a light of an LED reflected by the second end and transmitting the image data to a processor, thereby comparing and calculating the image data at different time points to obtain a vehicular rotation speed.

Preferably, the spindle includes a first end received in the spindle hole and a second end connected with a steel cable to be rotated, the base has a sensing window thereon, the scanner is located on the sensing window and contains a light source for lighting on the spindle through the sensing window, and an image grabbing unit forming and grabbing the image of a light from the light source reflected by the spindle, and transmitting the image data to a processor, thereby comparing and calculating the image data at different time points to obtain a vehicular rotation speed.

In accordance with a fourth aspect of the present invention, a vehicular rotation speed sensing apparatus is provided. The vehicular rotation speed sensing apparatus contains a base, an output shaft, a spindle pivoted inside the base and having a first end and a second end, wherein the first end is received in a spindle hole on the output shaft and rotated together with the spindle hole, and the second end is fastened to a steel cable, a magnetic force device mounted on the spindle, and a magnetic force sensor fixed on an outer surface of the base for measuring a variation of magnetic field lines of the magnetic force device.

Preferably, the magnetic force sensor and the base are mutually fixed by a holder.

Preferably, the magnetic force sensor is fastened to the base by a cable tie.

Preferably, a magnetic force device is mounted around a peripheral surface of the spindle.

Preferably, the magnetic force device is a magnetic strip sticker posted on the peripheral surface of the spindle.

Preferably, the sensing apparatus is fixed on a front wheel base of a motorcycle.

Preferably, the sensing apparatus is fixed on a gearbox.

The foregoing and other features and advantages of the present invention will be more clearly understood through the following descriptions with reference to the drawing, wherein:

### BRIEF DESCRIPTION OF THE DRAWINGS

FIG. 1 is a schematic view showing the conventional vehicular rotation speed sensing apparatus according to the prior art;

FIG. 2 is a schematic view showing another conventional vehicular rotation speed sensing apparatus according to the prior art;

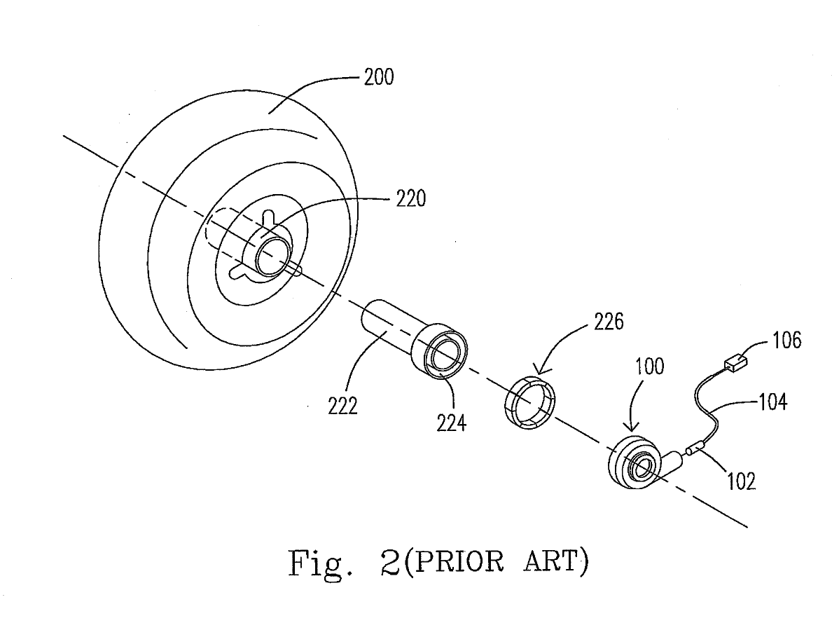

FIG. 3 is a schematic view showing the internal structure of the vehicular rotation speed sensing apparatus of the present invention;

FIG. 4 is a schematic view showing the structure of the vehicular rotation speed sensing apparatus according to a first embodiment of the present invention;

FIG. 5 is a schematic view showing the structure of the vehicular rotation speed sensing apparatus according to a second embodiment of the present invention;

FIG. 6 is a schematic view showing the structure of the vehicular rotation speed sensing apparatus according to a third embodiment of the present invention;

FIG. 7 is a schematic view showing the structure of the vehicular rotation speed sensing apparatus according to a fourth embodiment of the present invention;

FIG. 8 is a schematic view showing the structure of the vehicular rotation speed sensing apparatus according to a fifth embodiment of the present invention;

FIG. 9 is a schematic view showing the structure of the vehicular rotation speed sensing apparatus according to a sixth embodiment of the present invention;

FIG. 10 is a schematic view showing the structure of the vehicular rotation speed sensing apparatus according to a seventh embodiment of the present invention; and

FIG. 11 is a schematic view showing the structure of the vehicular rotation speed sensing apparatus according to a eighth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

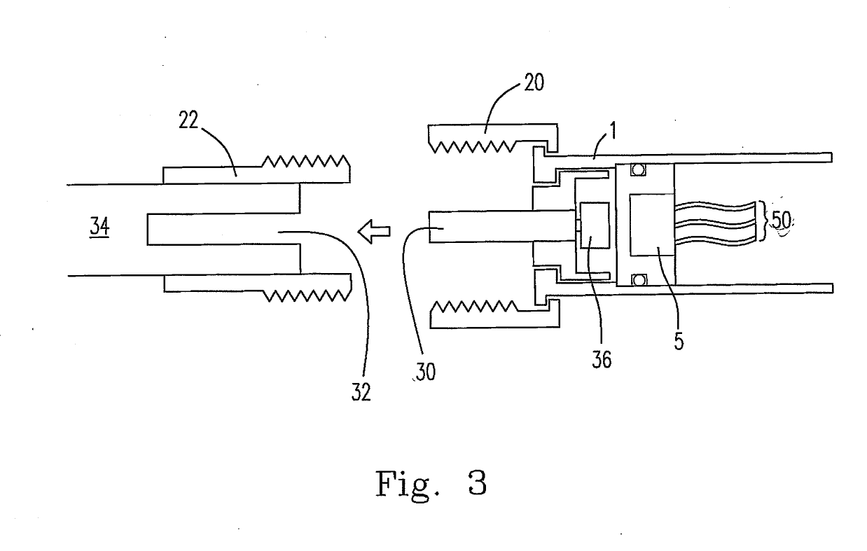

Please refer to FIG. 3 showing the internal structure of the vehicular rotation speed sensing apparatus of the present invention, in which the output shaft 34 had a spindle hole 32 and is pivoted inside an output shaft seat 22. These two parts are prevalent in those of the front wheel of the existing motorcycle (not shown) and the present invention is developed thereon. That is to say, the present invention is directly applicable for the existing motorcycle.

As shown in FIG. 3, the spindle 30 is pivoted inside a base 1, in which one end of the spindle 30 is inserted in the spindle hole 32 and jointly rotated therewith, and the other end thereof is equipped with a magnetic force device 36, e.g. a magnet. A magnetic force sensor 5, typically the component like the Hall chip, is mounted at the position where is adjacent to the magnetic force device 36 in the base 1. Hence, when the spindle 30 is rotated together with the output shaft 34 as a result of the rotation of the front wheel, the magnetic force sensor 5 is able to sense the variation of the magnetic field lines caused by the displacement of the rotating magnetic force device 36 in relative to the magnetic force sensor 5 so as to generate a resulting signal transmitted to an electronic display panel (not shown) via a signal line 50. The base 1 is fixed on the output shaft seat 22 by means of a fixing part 20. As it is feasible for the present invention to be directly applied to the front wheel of the existing motorcycle, both the spindle 30 and the fixing part 20 shall all meet the dimension specifications of the front wheel of the existing motorcycle in order to benefit from the advantage in continuously operating the existing equipment at no additional charge as well as the accuracy and convenience of the electronic component at the same time.

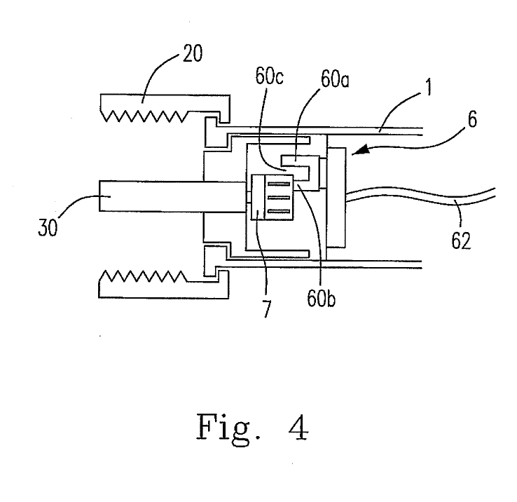

Please refer to FIG. 4 showing the structure of the vehicular rotation speed sensing apparatus according to a first embodiment of the present invention, in which the spindle 30, the fixing part 20 and the base 1 thereof are similar to those shown in FIG. 3. In addition, the vehicular rotation speed sensing apparatus includes a grating 7 disposed on the spindle 30 pivoted inside the base 1, an optoelectronic sensor 6 disposed in the proximity of the grating 7, a light-emitting component 60a and a receiving component 60b disposed on top of the optoelectronic sensor 6, and a rotation space 60c formed between the two components, so that the grating 7 is configured therein. The rotation of the grating 7 sporadically blocks the light path between the light-emitting component 60a and the receiving component 60b, which makes the rotation speed, the estimated information such as speed, acceleration, mileage and the like of the vehicle accessible. Certainly, the respective positions of the optoelectronic sensor 6 and the grating 7 are interchangeable. However, due to the power requirement of the optoelectronic sensor 6, it is preferably disposed on the base 1.

As shown in FIG. 4, the aperture orientation of the grating 7 is in a radial form, which diverges from the center axis of the spindle 30. That is, the shape of grating 7 resembles a cylinder and its apertures are located on the wall of the cylinder. The opening orientation of the rotation space 60c is parallel with the axial direction of the spindle 30 so as to accommodate and rotate the grating 7 therein. Consequently, both of the grating 7 and the optoelectronic sensor 6 are able to be inserted by the base 1 along the axial direction thereof. Thus, the grating 7 is smoothly entered the rotation space 60c without colliding with the light-emitting component 60a or the receiving component 60b. The aperture of the grating 7 is not limited to be a through hole or an opening as long as it is transparent to the emitted light of the light-emitting component 60a. In other words, the grating 7 is functional by using a transparent film with plural opaque stripes printed thereon. The signals are transmitted from the optoelectronic sensor 6 to an electronic display panel (not shown) via a transmission line 62, which is an optical fiber.

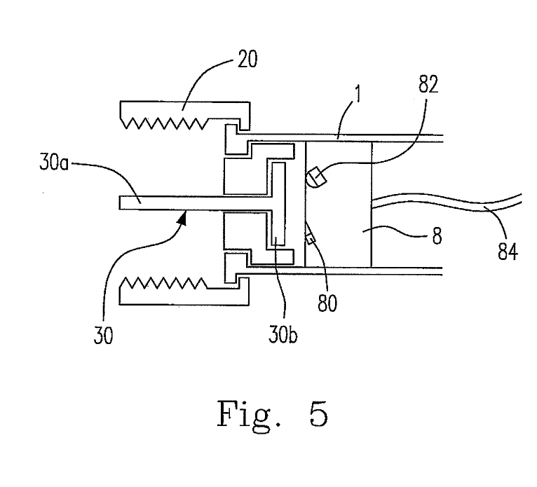

Please refer to FIG. 5, which is a schematic view showing the structure of the vehicular rotation speed sensing apparatus according to a second embodiment of the present invention, in which the base 1 and the fixing part 20 are similar to those of the mentioned embodiment in regard to the base 1 and fixing part 20. The difference exists in that the spindle 30 is divided into a first end 30a and a second end 30b, in which the first end 30a is inserted in a spindle hole, i.e. the spindle hole 32 shown in FIG. 3, and thereby the rotation of the wheel (not shown) is able to be transmitted to the spindle 30. The second end 30b is coupled with a scanner 8 that is fixed inside the base 1, so as to detect the rotating state of the wheel by scanning the rotation of the second end 30b. Inside the scanner 8 are a light source 80 and an image grabbing unit 82. The light source 80 is usually built by an LED, and the image grabbing unit 82 presents the image formed by the reflected light from the second end 30b and converts the image data into an electronic signal to be transmitted to an electronic display panel (not shown) via a transmission line 84. The working principle of the embodiment shown in FIG. 5 is analogous to that of the prevalent cordless optical mouse.

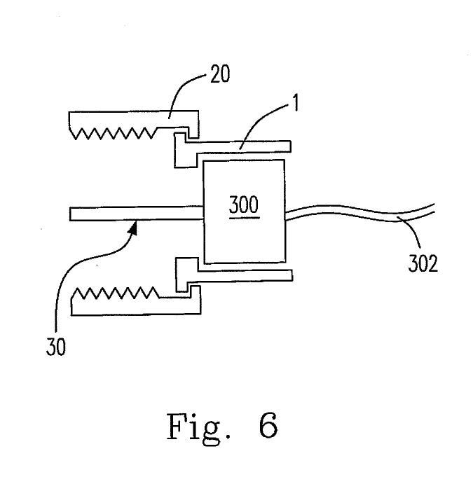

Please refer to FIG. 6 showing the structure of the vehicular rotation speed sensing apparatus according to a third embodiment of the present invention, wherein the spindle 30 is the power input shaft of a power generator 300. As such, the power generated by the power generator 300 is transmitted to an electronic display panel (not shown) via a power line 302 when wheel transmits the horse power to the power generator 300 through the spindle 30. That is, the rotation condition of the wheel is measurable through the power generation. In addition, the means of power generation is also served as an additional power supply to the electronic display panel.

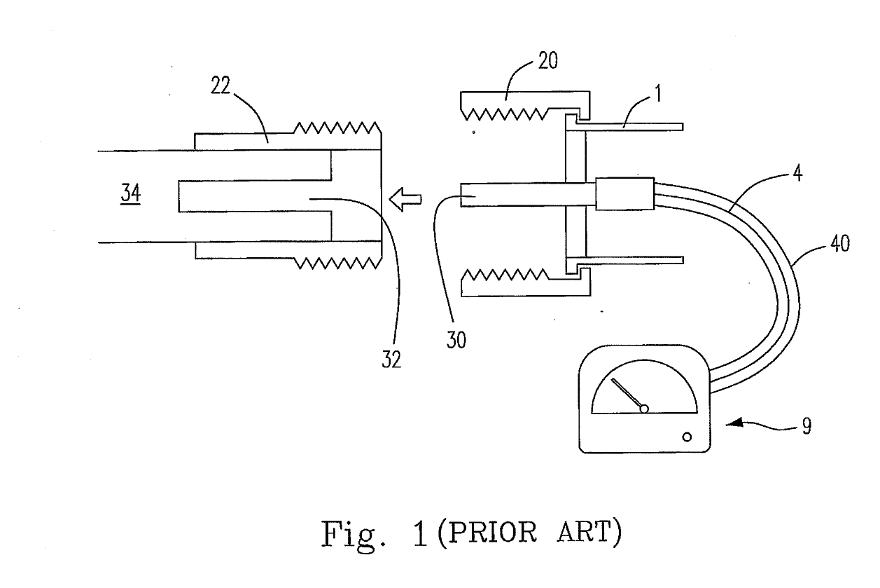

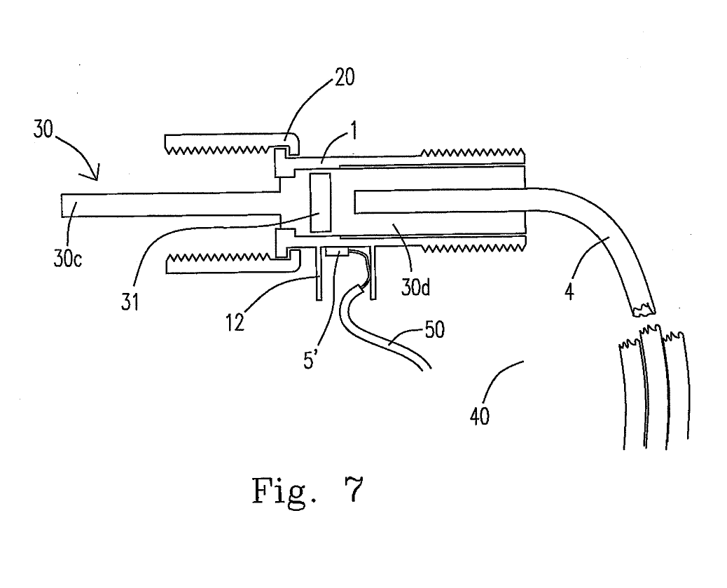

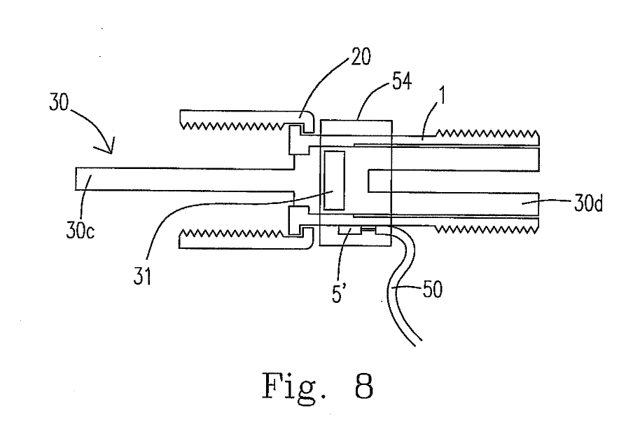

Please refer to FIG. 7 showing the structure of the vehicular rotation speed sensing apparatus according to a fourth embodiment of the present invention, in which the output shaft 34 is bored a spindle hole 32 and is pivoted inside an output shaft seat 22, and these two parts are commonly used in the existing front wheel (not shown) or in the gearbox (not shown) of the motorcycle. A spindle 30 is pivoted inside a base 1, wherein the first end 30c of the spindle 30 is inserted in the spindle hole 32, and the second end 30d is connected with a steel cable 4 so that the rotation of the spindle 30 is directly transmitted to the speedometer 9 (shown in FIG. 1) by the mechanical means. To protect the steel cable 4 from abrasion, it is covered with a jacket 40. The fundamental concept of the present invention lies in directly utilizing those available to the existing motorcycles. The embodiment shown in FIG. 7 is evolved from such concept. In other words, the electronic rotation speed sensor is still applicable without impacting on the structure of the existing mechanical rotation speed sensor. As shown in FIG. 7, a magnetic force device 31, e.g. a magnet, is directly disposed on the spindle 30. Typically, the magnetic force device 31 is disposed on the side of the spindle 30. Besides, a magnetic force sensor 5′ is disposed outside the base 1. Preferably, the magnetic force sensor 5′ is disposed at a nearest location on the base 1 to the magnetic force device 31, so that the distance between the magnetic force device 31 and the magnetic force sensor 5′ is as short as possible. This effectively enhances the sensing function. As for the magnetic force sensor 5′, it is fixed outside the base 1 by means of a holder 12. Please further refer to FIG. 8, which is a schematic view showing the structure of the vehicular rotation speed sensing apparatus according to a fifth embodiment of the present invention. The magnetic force sensor 5′ is bound on the outer surface of the base 1 by a binder 54 or a cable tie (not shown). Alternatively, the magnetic force sensor 5′ is fixed on the base 1 with glue. Moreover, to enhance the convenience in operation, the magnetic force device 31 takes the form of a magnetic strip sticker being directly posted on the surface of the spindle 30.

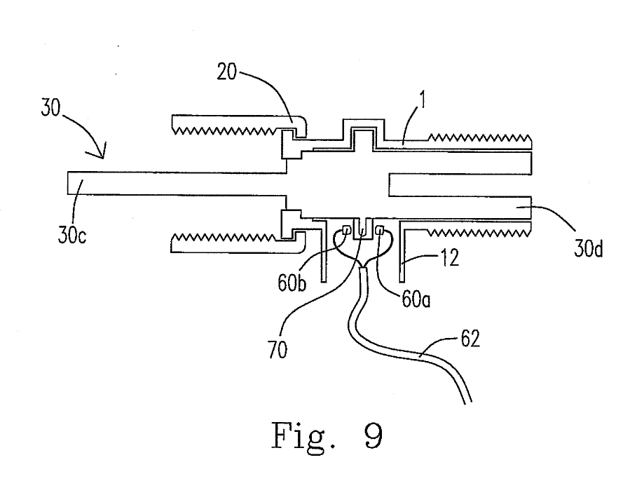

Please refer to FIG. 9 showing the structure of the vehicular rotation speed sensing apparatus according to a sixth embodiment of the present invention, wherein the output shaft 34 is bored a spindle hole 32 and pivoted inside an output shaft seat 22, and these two parts are commonly used in existing front wheel (not shown) or in the gearbox (not shown) of the motorcycle. A spindle 30 is pivoted inside a base 1, wherein the first end 30c of the spindle 30 is inserted in the spindle hole 32 and the end 30d is connected with a steel cable 4 so that the rotation of the spindle 30 is directly transmitted to the speedometer 9 (shown in FIG. 1) by the mechanical means. To protect the steel cable 4 from abrasion, it is covered with a jacket 40. The fundamental concept of the present invention lies in directly utilizing those available to the existing motorcycles. The embodiment shown in FIG. 9 is evolved from the concept. In other words, the electronic rotation speed sensor is still applicable without impacting on the structure of the existing mechanical rotation speed sensor. As shown in FIG. 9, it is another type of the vehicular rotation speed sensing apparatus which includes a base 1 and a spindle 30 consisting of a first end 30c and a second end 30d pivoted therein. The first end 30c is inserted in a spindle hole 32 shown in FIG. 3 so as to rotate along with the output shaft 34 shown in FIG. 3, and the second end 30d is connected with a steel cable, which is similar to those of the conventional technique. However, to fulfill the concept of the present invention, the embodiment encompasses the conventional display panel and the electronic sensor in simultaneous operation, adding that a grating 70 is further disposed on the spindle 30. The grating 70 is unique in being disposed around the outer surface of the spindle 30. In other words, the structure of the grating 70 extends radially from the outer surface of the spindle 30 and the aperture orientation of the grating 70 is parallel with the axial direction of the spindle 30. Therefore, the grating 70 is disposed in the space formed between the light-emitting component 60a and the receiving component 60b of the optoelectronic sensor. Furthermore, both of the light-emitting component 60a and the receiving component 60b are fastened on the base 1 by means of a holder 12 and the received signal is transmitted to an electronic display panel (not shown) via a transmission line 62.

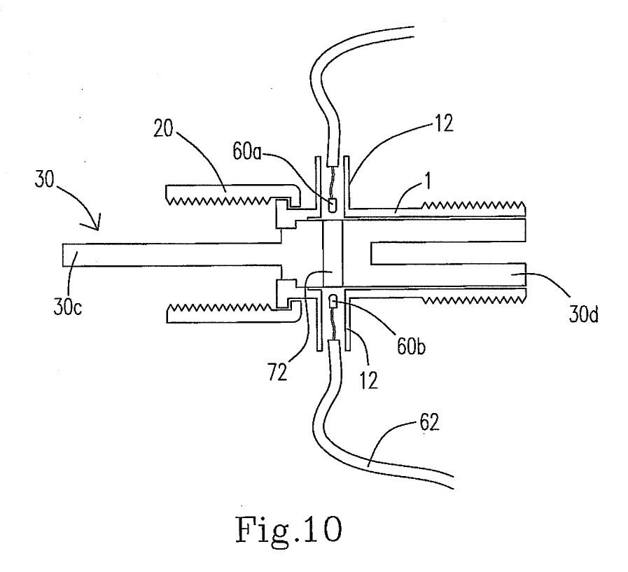

Please refer to FIG. 10 showing the structure of the vehicular rotation speed sensing apparatus according to a seventh embodiment of the present invention, wherein the basic structure is identical to that shown in FIG. 9 with the exception of the grating 72. The aperture of the grating 72 in FIG. 10 penetrates through the spindle 30 in the radial direction. The simplest way to understand this is to drill a through hole through the spindle 30 in the radial direction. For balancing the spindle 30, the through hole usually passes through the center axis of the spindle 30 so as to locate the center of gravity of the spindle 30 at the center axis thereof. A light-emitting component 60a and a receiving component 60b are disposed on the locations of the base 1 where correspond to both ends of the grating 72 respectively. As a result, the receiving component 60b receives the light emitted from the light-emitting component 60a when both sides of the grating 72 are aimed respectively at the light-emitting component 60a and the receiving component 60b. In addition, the grating 72 blocks the light emitted from the light-emitting component 60a when the grating 72 is not positioned to aim at the receiving component 60b due to its rotation.

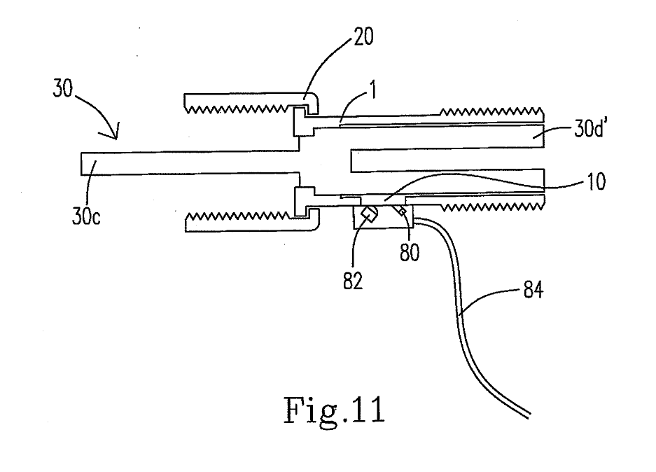

Please refer to FIG. 11 showing the structure of the vehicular rotation speed sensing apparatus according to a eighth embodiment of the present invention, wherein the basic structure is identical to that in FIG. 9 except the scanner 8 in place of the grating-type component. For attaining the fundamental concept of the present invention and keeping the original mechanical speedometer, a light source 80 and an image grabbing unit 82 are provided. The scanner 8 is used to scan the side of the spindle 30. The side of the base 1 has a sensing window 10 to expose the spindle 30 to the scanner so that the rotation of the spindle 30 is detected by the scanner 8. The scanned image is transmitted to an electronic display panel (not shown) via a transmission line 80. Moreover, the sensing window 10 is opened by driver or retailer. The scanner 8 would be also fixed with the binder 54 shown in FIG. 8 later on. Hence, it is advantageous that the existing spindle 30 and the existing base 1 are both applicable in this embodiment so as to cooperate with the scanner 8 in the present invention.

In summary, the key points of the mentioned embodiments are that the spindle 30 is bundled with the output shaft 34 of the front wheel of the existing motorcycle and the fixing part 20 is also bundled with the existing output shaft seat 22. Therefore, it is unnecessary for the parts of front wheel of motorcycle to be redesigned and the existing parts are applicable in the present invention. The user or the driver can directly take apart the rotation speed sensing apparatus of the conventional mechanical transmission type shown in FIG. 1, and directly dispose the apparatus of the present invention to the front wheel of motorcycle in accordance with the motorcycle model and the apparatus with the corresponding specifications so that most parts of front wheel of motorcycle are applicable without being modified. Above all, the embodiments of the present invention shown in FIG. 7 to FIG. 11 respectively are advantageous in that the newly added electronic sensor and the display panel are compatible with the existing rotation speed sensing apparatus such as the steel cable 4 and the speedometer 9. Accordingly, the user can simultaneously operate the mechanical display panel and the electronic display panel, and such redundancy serves for the purpose of mutual backup and calibration. Based on the above, the present invention addresses a convenient and inexpensive choice regardless of the concerns from user or manufacturer.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A vehicular rotation speed sensing apparatus, comprising:
a base;
a spindle pivoted inside said base and rotating in a spindle hole, wherein said spindle has a center with an extension line passing through a middle point between a North and a South Pole of said magnetic force device;
a magnetic force device mounted on one end of said spindle; and
a magnetic force sensor mounted on said base along an axial direction of said spindle so as to sense a variation of magnetic field lines of said magnetic force device located between said spindle and said magnetic force sensor.

2. The sensing apparatus of claim 1, wherein said magnetic force device is mounted on an end face of said spindle.

3. The sensing apparatus of claim 1, comprising a metal wire, wherein a signal is outputted by said magnetic force sensor via said metal wire.

4. The sensing apparatus of claim 1, comprising an optical fiber, wherein a signal is outputted by said magnetic force sensor via said optical fiber.

5. The sensing apparatus of claim 1, being fixed on a front wheel base of a motorcycle.

6. The sensing apparatus of claim 1, being fixed on a gearbox.

7. A vehicular rotation speed sensing apparatus, comprising:
a base;
a spindle pivoted inside said base, rotating in a spindle hole and having a grating disposed thereon; and
an optoelectronic sensor fixed on said base for sensing a grating motion.

8. The sensing apparatus of claim 7, wherein an aperture orientation of said grating is disposed and has a center point being a center of said spindle, and said optoelectronic sensor comprises:
a light-emitting component; and
a receiving component mounted opposite to a luminescing direction of said light-emitting component in formation of a rotation space between said receiving component and said light-emitting component with said aperture orientation of said rotation space in parallel with an axial direction of said spindle so as to accommodate said grating to be rotated within said rotation space.

9. The sensing apparatus of claim 7, wherein said grating is mounted around a periphery of said spindle, an aperture orientation of said grating is parallel with an axial direction of said spindle, said optoelectronic sensor comprises a light-emitting component and a receiving component, mounted opposite to a luminescing direction of said light-emitting component in formation of a rotation space between said receiving component and said light-emitting component so as to accommodate said grating to be rotated within said rotation space.

10. The sensing apparatus of claim 7, wherein an aperture orientation of said grating is positioned alongside an axial direction of said spindle, and said optoelectronic sensor comprises a light-emitting component mounted on said base and a receiving component mounted on said base opposite to said light-emitting component, and said grating is located between said light-emitting component and said receiving component.

11. The sensing apparatus of claim 7, wherein said optoelectronic sensor employs an IR as a light source.

12. The sensing apparatus of claim 7, being fixed on a front wheel base of a motorcycle.

13. The sensing apparatus of claim 7, being fixed on a gearbox.

14. A vehicular rotation speed sensing apparatus, comprising:
a base;
a spindle pivoted inside said base and rotated together with a spindle hole; and
a scanner fastened on said base for scanning a rotation of said spindle.

15. The sensing apparatus of claim 14, wherein said spindle comprises a first end received in said spindle hole and a second end, and said scanner comprises:
a light source; and
an image grabbing unit grabbing an image data formed by a light of an LED reflected by said second end and transmitting said image data to a processor, thereby comparing and calculating said image data at different time points to obtain a vehicular rotation speed.

16. The sensing apparatus of claim 14, wherein said spindle comprises a first end received in said spindle hole and a second end connected with a steel cable to be rotated, said base has a sensing window thereon, said scanner is located on said sensing window and comprises:
a light source for lighting on said spindle through said sensing window; and
an image grabbing unit forming and grabbing said image of a light from said light source reflected by said spindle, and transmitting said image data to a processor, thereby comparing and calculating said image data at different time points to obtain a vehicular rotation speed.

17. A vehicular rotation speed sensing apparatus, comprising:
a base;
an output shaft;
a spindle pivoted inside said base and having a first end and a second end, wherein said first end is received in a spindle hole on said output shaft and rotated together with said spindle hole, and said second end is fastened to a steel cable;
a magnetic force device mounted on said spindle; and
a magnetic force sensor fixed on an outer surface of said base for measuring a variation of magnetic field lines of said magnetic force device.

18. The sensing apparatus of claim 17, wherein said magnetic force sensor and said base are mutually fixed by a holder.

19. The sensing apparatus of claim 17, wherein said magnetic force sensor is fastened to said base by a cable tie.

20. The sensing apparatus of claim 17, wherein a magnetic force device is mounted around a peripheral surface of said spindle.

21. The sensing apparatus of claim 20, wherein said magnetic force device is a magnetic strip sticker posted on said peripheral surface of said spindle.

22. The sensing apparatus of claim 17, being fixed on a front wheel base of a motorcycle.

23. The sensing apparatus of claim 17, being fixed on a gearbox.
